(19) United States
(12) Patent Application Publication
(10) Pub. No.: US 2016/0273410 A1
(43) Pub. Date: Sep. 22, 2016

(54) THERMAL POWER PLANT WITH USE OF THE WASTE HEAT FROM A GENERATOR

(71) Applicant: SIEMENS AKTIENGESELLSCHAFT, Munich (DE)

(72) Inventors: Esteban Grau Sorarrain, Düsseldorf (DE); Christian Jäkel, Duisburg (DE); Mario Koebe, Mülheim an der Ruhr (DE); Matthias Kowalski, Mülheim an der Ruhr (DE); Christoph Lehmann, Neukirchen-Vluyn (DE); Andrey Mashkin, Köln (DE); Olga Plotnikova, Wuppertal (DE); Carolin Schild, Mülheim an der Ruhr (DE)

(73) Assignee: Siemens Aktiengesellschaft, Munich (DE)

(21) Appl. No.: 15/033,231

(22) PCT Filed: Sep. 18, 2014
(86) PCT No.: PCT/EP2014/069867

§ 371 Date: Apr. 29, 2016

(30) Foreign Application Priority Data
Nov. 5, 2013 (EP) 13191596.9

(51) Int. Cl. F01K 27/02; F01D 15/10; C10L 9/08; F01K 7/16

(52) U.S. Cl. CPC F01K 27/02; F01K 7/16; F01D 15/10; C10L 9/08; F05D 2220/31; C10L 2290/08; C10L 2290/06

(57) ABSTRACT

A thermal power plant with a generator, includes a cooling system for the generator, wherein the waste heat released from the generator on cooling can be used profitably for operating the thermal power plant, including drying fuel, in particular for drying coal. In a method for using waste heat of a generator of a thermal power plant, the waste heat of the generator is used for drying fuel, in particular for drying coal.

### CROSS REFERENCE TO RELATED APPLICATIONS

This application is the US National Stage of International Application No. PCT/EP2014/069867 filed Sep. 18, 2014, and claims the benefit thereof. The International Application claims the benefit of European Application No. EP13191596 filed Nov. 5, 2013. All of the applications are incorporated by reference herein in their entirety.

### FIELD OF INVENTION

The invention relates to a thermal power plant in which the waste heat from a generator can be used.

### BACKGROUND OF INVENTION

In thermal power plants, also referred to as steam power plants, great effort is made to achieve the greatest possible efficiency in converting heat released by combustion of fossil fuels or by nuclear fission into mechanical and ultimately electrical energy.

An essential strategy in that context is to not completely expand all of the steam, but to remove some of this beforehand and use it primarily for preheating the feed water.

Often, the heat released is also partially used for heating purposes or otherwise as process heat. Also, in order to permit this use of heat, a somewhat reduced generation of electrical energy is accepted.

Insofar as heat is removed for other purposes, this is often not discussed as efficiency, which is normally the ratio of electrical energy obtained to combustion energy or nuclear fission energy expended. For differentiation, reference is occasionally made to a degree of energy utilization, in which, in addition to the electrical energy obtained, the useful thermal energy is also taken into account.

DE 20 2012 006 055 U1 describes a device for generating electrical energy using an organic Rankine cycle in conjunction with a turbine generator. The document explains that the cooling jacket of the turbine generator has a process fluid flowing through it and the heat extracted from the turbine generator is fed back to the working fluid of the organic Rankine cycle.

DE 197 53 264 C1 discloses a gas turbine plant in which intake air that is to be supplied to the compressor of a gas turbine can be preheated using waste air from an air-cooled generator.

WO 2007/132312 A2 discloses a fuel-drying system which uses waste heat from the condenser. To that end, the heat is extracted by a heat exchanger from the fluid circuit leading from the condenser to the cooling tower.

### SUMMARY OF INVENTION

An object of the invention is to achieve a further improvement in the efficiency or in the degree of energy utilization, that is to say increased production of electrical energy or increased use of released heat for other purposes.

This object is achieved with the independent claims. Advantageous configurations can be found in the subclaims.

It has been recognized that it is necessary to provide a thermal power plant with a generator, having a cooling system for the generator, wherein the waste heat of the generator, released during cooling, can be used for drying fuel, in particular for drying coal. In that context, it is normally in any case necessary to provide a cooling system for the generator. Hitherto, the heat was generally given off, unused, to the environment. It is known that the waste heat can be used for heating purposes. It has now been recognized that the heat can also be used beneficially for the operation of the thermal power plant. In so doing, less steam need be extracted prior to complete expansion, such that this steam is available for generating electrical energy or for other purposes. In the interests of combustion which is as controlled as possible and thus as low as possible in harmful substances, it is expedient to dry the fuel which is used. Since the energy required for drying would in any case be required during combustion, no energy is lost. Since the energy, or more precisely the heat, required for drying is required at a relatively low temperature, it is also thermodynamically more advantageous to first dry the fuel with low-temperature heat than to accept a reduction in the heat available at combustion temperature. For these reasons, fuel drying is common in the prior art. However, hitherto steam has been bled from a turbine before it has been completely expanded. With the invention, less steam need be extracted prior to complete expansion, such that this steam is available for generating electrical energy or for other purposes.

In one embodiment of the invention, a coolant circuit is present for cooling the generator, wherein the coolant circuit has a heat exchanger by means of which waste heat taken up by the coolant during cooling of the generator can be given off for heating materials that are to be heated. The coolant can be various fluids. In that context, use can be made of gaseous fluids such as air or hydrogen, but liquid fluids such as water are also conceivable.

In one embodiment of the invention, the waste heat can be used to preheat feed water. Preheating feed water with steam which has been diverted from the turbine before it has been completely expanded is a routine measure for increasing efficiency. By using waste heat from the generator, less steam need be extracted prior to complete expansion, such that this steam is available for generating electrical energy or for other purposes.

In one embodiment of the invention, the feed water from the condenser can be heated using the waste heat of the generator before being heated in another manner. This means that the first targeted heating of the feed water takes place using the waste heat of the generator after the feed water has left the condenser. This is not intended to exclude the possibility of limited heating, for example by ambient heat, taking place prior to heating using the waste heat of the generator. However, it should be stated that, in this embodiment, no other targeted heating should take place prior to heating using the waste heat. This is intended to prevent the temperature of the feed water being already so high that the temperature of the waste heat is no longer sufficient for heating. It should be borne in mind, in this context, that temperature differences are always necessary for a transfer of heat. Thus, a temperature difference is required in order to transfer the heat from the generator to the coolant and, in turn, from the coolant to the feed water—or to other materials to be heated.

It should be mentioned at this point that the waste heat is relatively low-temperature heat, such that normally the only alternative is steam which has been bled at relatively low pressure and accordingly low temperature prior to complete expansion. Thus, using the waste heat of the generator saves steam which can provide only a negligible contribution to the mechanical work and to the electrical power. Nonetheless, the invention provides a relevant contribution to raising the efficiency of a thermal power plant.

In one embodiment of the invention, which develops the heating of the feed water using waste heat prior to another method of heating, the feed water from the condenser can be conveyed directly into a heat exchanger for exchange of heat from the coolant to the feed water. Direct conveyance is to be understood as meaning that, ignoring lines and possible pumps and valves, no significant components are present. As already explained above, the intended result of this is that the first significant heating of the feed water from the condenser is effected using the waste heat of the generator, that is to say in the present case in the heat exchanger.

However, it is not absolutely necessary to feed the feed water from the condenser directly into the heat exchanger. Thus, another type of treatment, for example purification, could be carried out first. In general, however, it should be unavoidable that no other heating takes place prior to heating using the waste heat of the generator, since otherwise the temperature of the waste heat would be too low.

In one embodiment of the invention, the waste heat can be used to preheat combustion air. The air required for combustion, that is to say the air which contains the oxygen necessary for combustion, is sometimes preheated. It is thermodynamically more advantageous to first preheat the air with low-temperature heat than to accept a reduction in the heat available at combustion temperature. Since the combustion air is supplied at the ambient temperature of the thermal power plant, that is to say at a relatively low temperature, preheating using the waste heat of the generator represents an expedient use of the waste heat. For practical implementation, a heat exchanger is generally to be provided.

The invention also relates to an associated method.

### BRIEF DESCRIPTION OF THE DRAWINGS

Further details will be illustrated in greater detail below with reference to a figure.

The sole FIGURE shows a highly simplified representation of a thermal power plant in accordance with aspects of an embodiment of the invention.

### DETAILED DESCRIPTION OF INVENTION

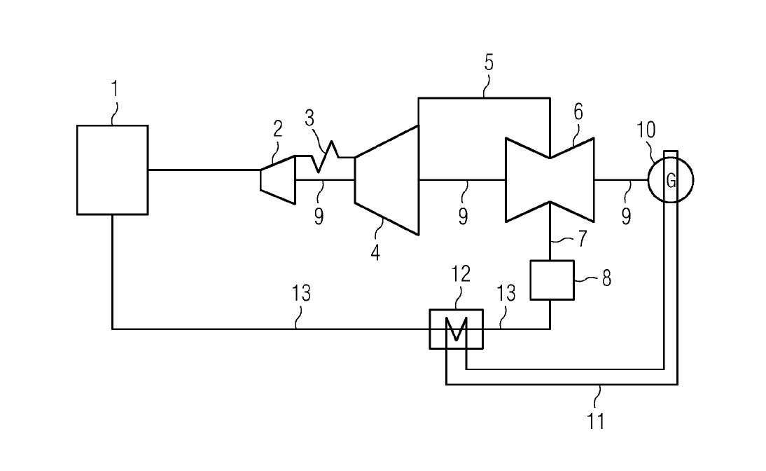

The FIGURE shows a highly simplified representation of a thermal power plant. The feed water is heated and evaporated in a boiler 1. The steam is fed via a line into a high-pressure turbine 2. After expansion of the steam in the high-pressure turbine 2, a line 3 leads to an intermediate-pressure turbine 4. In the process, the steam undergoes intermediate superheating, as indicated by the zigzags in line 3. From the intermediate-pressure turbine 4, the steam is fed via a line 5 into a low-pressure turbine 6. After expansion in the low-pressure turbine 6, the steam, which is already relatively wet, is fed via a line 7 into a condenser 8. The high-pressure turbine 2, the intermediate-pressure turbine 4 and the low-pressure turbine 6 are on a common shaft 9 which drives a generator 10 in which the mechanical energy is converted into electrical energy. This produces waste heat which is removed by a coolant circuit 11. The coolant circuit 11 leads to a heat exchanger 12. Feed water obtained from the condensation of steam in the condenser 8 is also fed, in a feed water line 13, through the heat exchanger 12. In the process, the waste heat removed from the generator 10 by the coolant circuit 11 is transferred to the feed water. Not shown in FIG. 1 are preheating stages arranged in the further course of the feed water line 13, in which stages the feed water is preheated using steam. To that end, and also not shown, the steam is bled from the low-pressure turbine 6 prior to complete expansion. Preheating in the heat exchanger 12 means that less steam is required for this, and so the efficiency can be increased.

Although the invention has been described and illustrated in more detail by way of the preferred exemplary embodiment, the invention is not restricted by the disclosed examples and other variations can be derived herefrom by a person skilled in the art without departing from the scope of protection of the invention.

1. A thermal power plant with a generator, having
a cooling system for the generator,
wherein waste heat of the generator, released during cooling, adapted to be used for drying fuel.

2. The thermal power plants as claimed in claim 1, further comprising:
a coolant circuit for cooling the generator,
wherein the coolant circuit has a heat exchanger by means of which waste heat taken up by the coolant during cooling of the generator is given off for heating materials that are to be heated.

3. The thermal power plant as claimed in claim 1,
wherein the waste heat can be used to preheat feed water.

4. The thermal power plant as claimed in claim 3,
wherein feed water from a condenser is heated using the waste heat of the generator before being heated in another manner.

5. The thermal power plant as claimed in claim 4,
wherein the feed water from the condenser is conveyed directly into the heat exchanger for exchange of heat from the coolant to the feed water.

6. The thermal power plant as claimed in claim 1,
wherein the waste heat is used to preheat combustion air.

7. A method for using waste heat of a generator of a thermal power plant, as claimed in claim 1, the method comprising:
drying fuel with the waste heat of the generator.

8. The thermal power plant as claimed in claim 1,
wherein the fuel comprises coal.

9. The method for using waste heat of a generator of claim 7,
wherein the fuel comprises coal.
